(19) United States
(12) Patent Application Publication
(10) Pub. No.: US 2025/0128775 A1
(43) Pub. Date: Apr. 24, 2025

(54) STATICALLY STABLE HEXAPEDAL WALKING ROBOT PLATFORM

(71) Applicants: Gowan ROWLAND, Scottsdale, AZ (US); Andrew DEROS, Tempe, AZ (US); Connor NAIL, Chandler, AZ (US); Tyler SMITH, Phoenix, AZ (US)

(72) Inventors: Gowan ROWLAND, Scottsdale, AZ (US); Andrew DEROS, Tempe, AZ (US); Connor NAIL, Chandler, AZ (US); Tyler SMITH, Phoenix, AZ (US)

(73) Assignee: Arizona Board of Regents on Behalf of Arizona State University, Scottsdale, AZ (US)

(21) Appl. No.: 18/926,152

(22) Filed: Oct. 24, 2024

Related U.S. Application Data
(60) Provisional application No. 63/592,872, filed on Oct. 24, 2023.
(60) Provisional application No. 63/592,883, filed on Oct. 24, 2023.

(51) Int. Cl. B62D 57/032; B25J 9/16; B25J 19/00; B25J 19/02

(52) U.S. Cl. CPC B62D 57/032; B25J 9/1697; B25J 19/0025; B25J 19/005; B25J 19/0054; B25J 19/02

(57) ABSTRACT

A walking rover system with a rover, a base station, and a tether extending between the rover and the base station. The rover has a rover body, a plurality of mobilizing legs, and a plurality of stabilizing legs. The stabilizing legs have one degree of freedom and the mobilizing legs have three degrees of freedom. The mobilizing legs and the stabilizing legs may alternate around the rover body such that each of the mobilizing legs is separated from adjacent mobilizing legs by a stabilizing leg and each of the stabilizing legs is separated from adjacent stabilizing legs by a mobilizing leg. The tether is configured to transmit electricity from the base station to the rover, transmit data gathered by the rover back to the base station, and support a weight of the rover and act as a mechanical rappel line between the base station and the rover.

### RELATED APPLICATIONS

This application claims the benefit of U.S. provisional patent application 63/592,872, filed Oct. 24, 2023, to Rowland et al., titled “STATICALLY STABLE HEXAPEDAL WALKING ROBOT PLATFORM,” and the benefit of U.S. provisional patent application 63/592,883, filed Oct. 24, 2023, to Rowland et al., titled “THERMALLY AND ELECTRICALLY INSULATED STRUCTURAL MEMBER FOR HIGH-VACUUM ENVIRONMENTS,” the entirety of the disclosures of which are hereby incorporated by this reference.

### TECHNICAL FIELD

This document relates to a walking rover designed to traverse challenging geological environments.

### BACKGROUND

Lunar exploration has historically been limited to the most accessible areas of the moon, leaving areas such as permanently shaded regions (“PSRs”) largely unexplored. Such regions have been inaccessible due to incline, slippery regolith, rocky terrain, or a combination thereof. Accessing and exploring these regions would require a rover with increased maneuverability. For example, typical state-of-the-art wheeled rover platforms can only descend slopes up to 30 degrees. Although most of the lunar surface is traversable by traditional rovers, some of the most geologically interesting and commercially important areas are guarded by steep, inaccessible areas.

### SUMMARY

Aspects of this document relate to a walking rover system, comprising a rover having a rover body configured to hold a scientific payload, a plurality of mobilizing legs mounted to the rover body, each mobilizing leg of the plurality of mobilizing legs having three actuators and three degrees of freedom, a plurality of stabilizing legs mounted to the rover body, each stabilizing leg of the plurality of stabilizing legs having one actuator and one degree of freedom, wherein each stabilizing leg is formed as a four-bar mechanism, and a plurality of cameras mounted to the rover body and configured to gather visual data to help the rover to navigate terrain, wherein the plurality of mobilizing legs and the plurality of stabilizing legs alternate around the rover body such that each of the plurality of mobilizing legs is separated from adjacent mobilizing legs of the plurality of mobilizing legs by a stabilizing leg of the plurality of stabilizing legs and each of the plurality of stabilizing legs is separated from adjacent stabilizing legs of the plurality of stabilizing legs by a mobilizing leg of the plurality of mobilizing legs, a base station having an electric power generator configured to convert incident sunlight into electric power, wherein the base station is configured to communicatively couple with a remote third party, and a tether extending between the rover and the base station, wherein the tether is configured to transmit electricity from the base station to the rover to power the rover, transmit data gathered by the rover back to the base station, and support a weight of the rover and act as a mechanical rappel line between the base station and the rover.

Particular embodiments may comprise one or more of the following features. The rover may further have an imaging instrument mounted to the rover body and configured to image and characterize surrounding geological features. The rover may further have a spectrometer mounted to the rover body and configured to identify concentrations of water ice. The rover may further have a rechargeable battery mounted to the rover body and configured to power the rover when the tether is unable to transmit electricity from the base station to the rover. The rover body may have a radiator configured to passively radiate heat from the rover body. Each of the plurality of mobilizing legs and each of the plurality of stabilizing legs may be configured to minimize heat conduction from the rover body. The rover may be configured to move into a hibernation position in which all of the legs of the plurality of stabilizing legs and of the plurality of mobilizing legs but three are lifted above a surface beneath the rover to reduce thermal conduction from the rover body. The rover may further comprise a tether spool mounted to the rover body configured to wind up and store an unused portion of the tether.

Aspects of this document relate to a walking rover system, comprising a rover having a rover body configured to hold a payload, a plurality of mobilizing legs mounted to the rover body, each mobilizing leg of the plurality of mobilizing legs having three actuators and three degrees of freedom, and a plurality of stabilizing legs mounted to the rover body, each stabilizing leg of the plurality of stabilizing legs having one actuator and one degree of freedom, wherein the plurality of mobilizing legs and the plurality of stabilizing legs alternate around the rover body such that each of the plurality of mobilizing legs is separated from adjacent mobilizing legs of the plurality of mobilizing legs by a stabilizing leg of the plurality of stabilizing legs and each of the plurality of stabilizing legs is separated from adjacent stabilizing legs of the plurality of stabilizing legs by a mobilizing leg of the plurality of mobilizing legs.

Particular embodiments may comprise one or more of the following features. The rover may further have an imaging instrument mounted to the rover body and configured to image and characterize surrounding geological features. The rover may further have a spectrometer mounted to the rover body and configured to identify concentrations of water ice. The rover may further have a rechargeable battery mounted to the rover body and configured to power the rover. The rover body may have a radiator configured to passively radiate heat from the rover body. Each of the plurality of mobilizing legs and each of the plurality of stabilizing legs may be configured to minimize heat conduction from the rover body. The rover may be configured to move into a hibernation position in which all of the legs of the plurality of stabilizing legs and of the plurality of mobilizing legs but three are lifted above a surface beneath the rover to reduce thermal conduction from the rover body.

Aspects of this document relate to a method of moving a walking rover system across a surface, the method comprising providing the walking rover system, the walking rover system comprising a rover body, a plurality of mobilizing legs mounted to the rover body, and a plurality of stabilizing legs mounted to the rover body, wherein each of the plurality of mobilizing legs has three degrees of freedom and each of the plurality of stabilizing legs has one degree of freedom, supporting the rover body above the surface with the plurality of stabilizing legs, while supporting the rover body above the surface with the plurality of stabilizing legs, lifting the plurality of mobilizing legs off of the surface, gathering visual data of the surface in a desired direction of motion, selecting a respective contact point on the surface and a respective contact pose for each of the plurality of mobilizing legs, positioning each of the plurality of mobilizing legs in the respective contact pose, and lowering each of the plurality of mobilizing legs to contact the surface at the respective contact point, transferring support of the rover body from the plurality of stabilizing legs to the plurality of mobilizing legs, lifting the plurality of stabilizing legs off of the surface, advancing the rover body with the plurality of mobilizing legs in the desired direction of motion, lowering the plurality of stabilizing legs to contact the surface, and transferring support of the rover body from the plurality of mobilizing legs to the plurality of stabilizing legs.

Particular embodiments may comprise one or more of the following features. The method may further comprise moving the plurality of mobilizing legs and the plurality of stabilizing legs out of a stowed position in which the plurality of mobilizing legs and the plurality of stabilizing legs are folded up against the rover body. The method may further comprise moving the walking rover system into a hibernation position in which all of the legs of the plurality of stabilizing legs and of the plurality of mobilizing legs but three are lifted above the surface to reduce thermal conduction from the rover body. Each of the plurality of mobilizing legs and each of the plurality of stabilizing legs may be configured to minimize heat conduction from the rover body. The plurality of mobilizing legs and the plurality of stabilizing legs may alternate around the rover body such that each of the plurality of mobilizing legs is separated from adjacent mobilizing legs of the plurality of mobilizing legs by a stabilizing leg of the plurality of stabilizing legs and each of the plurality of stabilizing legs is separated from adjacent stabilizing legs of the plurality of stabilizing legs by a mobilizing leg of the plurality of mobilizing legs.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements, and:

FIG. 1 illustrates a walking rover in a stowed position next to a base station according to some embodiments;

FIG. 2 illustrates a walking rover tethered to a base station according to some embodiments.

FIG. 3 is a front view of a walking rover according to some embodiments;

FIG. 4 is a side view of a walking rover according to some embodiments;

FIG. 5 is a top view of a walking rover according to some embodiments;

FIG. 6 is a cross-sectional view of a walking rover according to some embodiments;

FIG. 7 is a perspective view a leg of a walking rover with one degree of freedom according to some embodiments;

FIG. 8 is an exploded view a leg of a walking rover with one degree of freedom according to some embodiments;

FIG. 9 is a perspective view a leg of a walking rover with three degrees of freedom according to some embodiments;

FIG. 10 is an exploded view a leg of a walking rover with three degrees of freedom according to some embodiments;

FIG. 11 illustrates various foot designs for legs of a walking rover according to some embodiments;

FIG. 12 is an exploded view of a tether boom of a walking rover according to some embodiments;

FIG. 13 illustrates a walking rover in a hibernation configuration according to some embodiments;

FIG. 14 illustrates a walking rover in a fully stowed position for flight according to some embodiments;

FIG. 15 illustrates a walking rover in a partially unfolded position according to some embodiments; and

FIG. 16 illustrates a walking rover in a fully unfolded position according to some embodiments.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

There are areas on the moon that are inaccessible to wheeled rovers because the wheeled rovers can only navigate slopes of less than 36 degrees. This means that there are several areas of the moon that are surrounded by slopes that render the area completely inaccessible to wheeled rover technology. In addition to steep terrain, the lunar surface is subject to temperature swings exceeding several hundreds of degrees Kelvin over the lunar day-night cycle. Compounding the issue, the temperature change between the lunar permanently shaded regions (“PSRs”) and the sunlit region of the moon is thought to be an abrupt transition. These temperature extremes present major thermal challenges to any exploratory lunar rover.

The present disclosure is related to a rover system 100 or mobile platform configured to traverse challenging geological environments both on Earth and on other planetary bodies. The rover system 100 disclosed herein is designed to circumvent the technical challenges outlined above by altogether replacing wheels with an ultra-stable leg formation, making the rover system 100 a walking rover system 100. Utilizing legs instead of wheels allows the rover system 100 to strategically climb with well-placed foot positions over rocky or fluffy regolith terrain to access previously inaccessible areas. While the present disclosure focuses on inaccessible areas of the moon, the same concepts could be applied to access hard-to-reach areas of the Earth or any other planet as well.

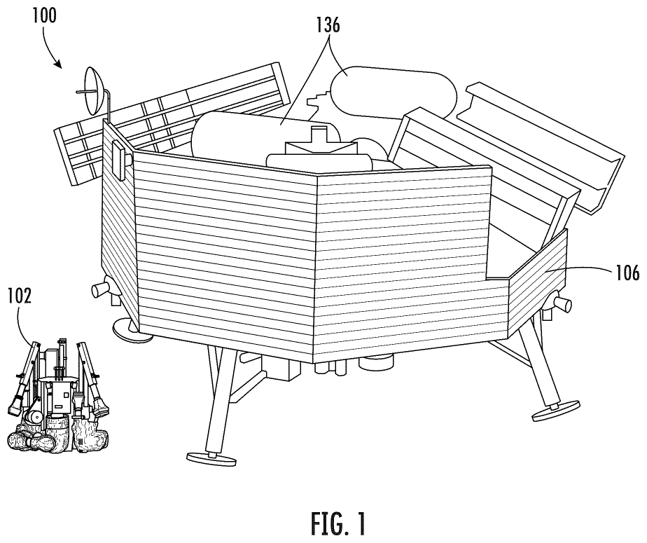

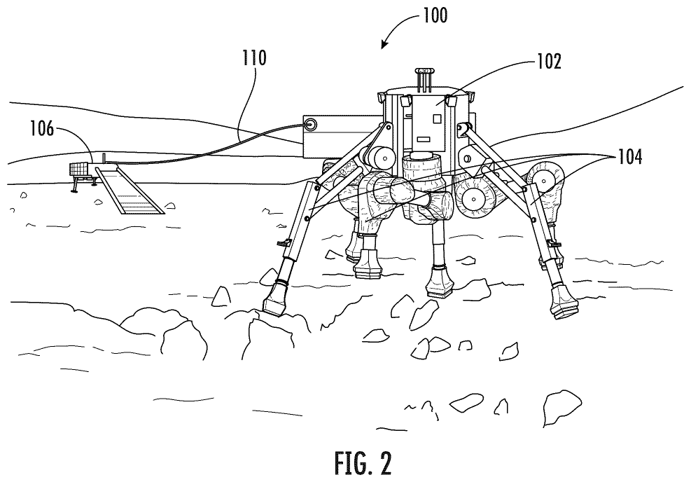

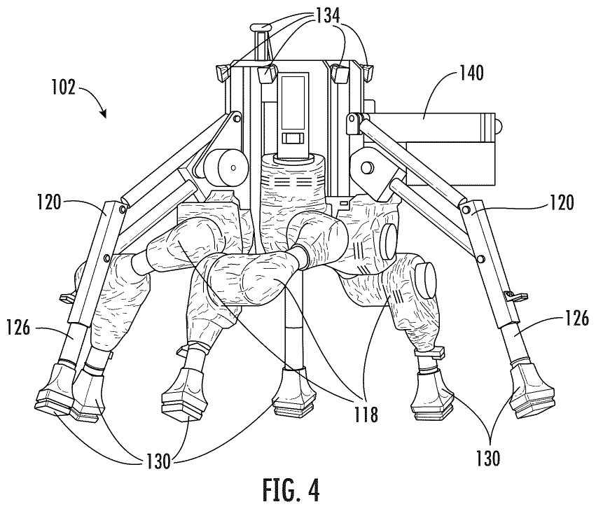

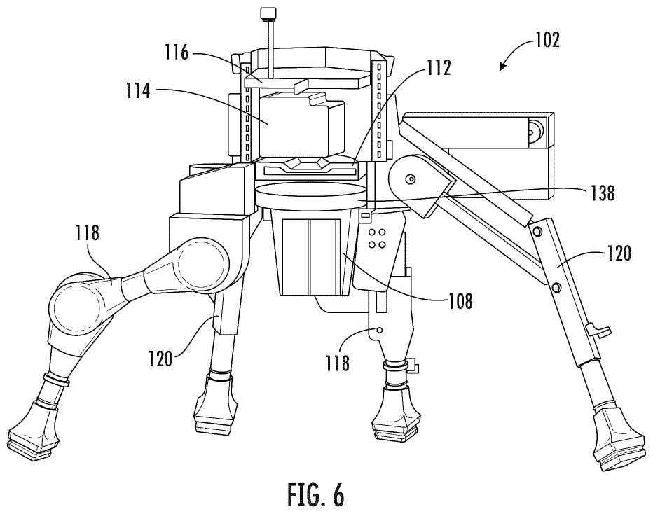

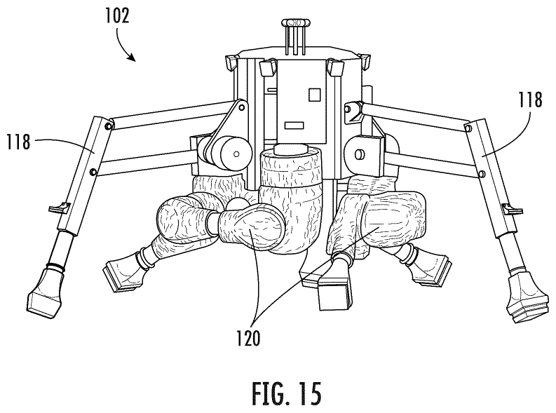

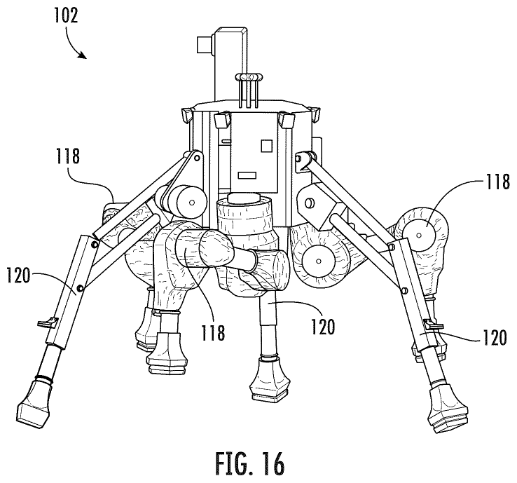

The rover system 100 is designed to prioritize stability, safety, and reliability, while also aiming to minimize complexity and overall system mass. As illustrated by the embodiment shown in FIGS. 1-16, the rover system 100 comprises a rover body 102 with a plurality of legs 104. The rover system 100 may be sized to be transported on a base station 106 such as that shown in FIG. 1. In some embodiments, the rover system 100 may be tethered to the base station 106, as shown in FIG. 2, to receive power from the base station 106 and/or communicate with the base station 106. The rover system 100 may be hexapedal. The rover body 102 may be constructed of 5052 aluminum, may be based on a monocoque fuselage design with an outer skin and interior formers and bulkheads to stiffen the structure, and may be riveted together using aluminum rivets. The rover body 102 may house a battery 108, a tether 110 spooled up during storage, electronics 112, a science payload 114, and a radiator 116, as shown in FIG. 6. In some embodiments, the rover system 100 may operate without a tether 110. In some embodiments, the legs 104 are mounted with fasteners to the bulk heads on the external surfaces of the rover body 102. DIN rail payload mounts may be attached to each side of the rover body 102 for additional features such as cameras and lights. The radiator 116, which may be a thermal radiator, may be integrated into the top of the rover body 102 and is configured to passively dissipate heat from the electronics 112. In some embodiments, the radiator 116 is configured for lunar south pole operation by using walls of the rover body 102 as shrouds to shield the radiator 116 from the sun.

The unique leg configuration and walking pattern disclosed herein provides several benefits, including improved stability, fewer actuators, and the ability to perform complex climbing and descent tasks. The leg configuration allows the center of mass of the rover system 100 to be kept central and low to the ground to increase stability.

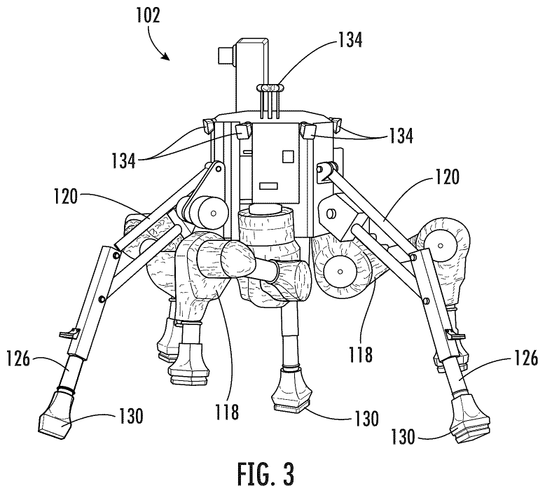

As shown in FIGS. 3-5, the plurality of legs 104 of the rover system 100 comprises two different types of legs, a mobilizing leg 118 and a stabilizing leg 120. The mobilizing leg 118 is configured to have at least two degrees of freedom and therefore allow the rover system 100 to move across a surface, while the stabilizing leg 120 is configured to support the rover system 100 on the surface while the mobilizing leg 118 lifts up and moves to a new position, and therefore can operate with only one degree of freedom. In some embodiments, the mobilizing legs 118 have three degrees of freedom.

Any number of mobilizing legs 118 and stabilizing legs 120 may be used. In some embodiments, the number of mobilizing legs 118 is equal to the number of stabilizing legs 120. For example, the rover system 100 may have three mobilizing legs 118 and three stabilizing legs 120. This allows the rover system 100 to always have at least three legs on the ground. The mobilizing legs 118 and the stabilizing legs 120 may alternate around the 102 of the rover system 100 such that each mobilizing leg 118 is separated from adjacent mobilizing legs 118 by a stabilizing leg 120 and each stabilizing leg 120 is separated from adjacent stabilizing legs 120 by a mobilizing leg 118.

The unique combination of the mobilizing legs 118 and the stabilizing legs 120 allows the rover system 100 to employ a walking strategy that improves the stability of the rover system 100 because the rover system 100 is always supported in a tripod configuration. This allows for fine control over locomotion power consumption and does not require burst power consumption to remain stable or balanced. Additionally, this leg configuration allows for fewer actuators compared to any other rover with the same level of mobility and stability. The rover thus consumes less power and is capable of long-range exploration of mountains, craters, and other geological features.

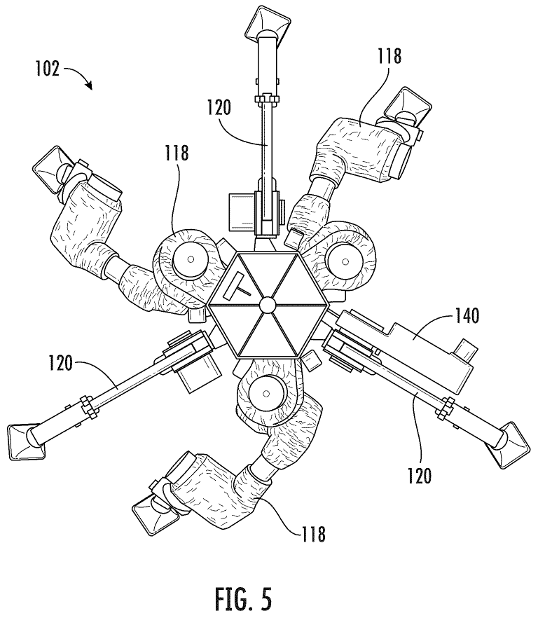

Additionally, the rover system 100 has a lower mass due to having fewer actuators 122. For example, as shown in the embodiment illustrated in FIG. 5, instead of six 3-DOF legs (18 actuators), the rover system 100 may have three 3-DOF mobilizing legs 118 and three 1-DOF stabilizing legs 120 (12 actuators). This provides a ⅓ reduction in actuators 122 which minimizes complexity and mass. Thus, the rover system 100 of the present disclosure is well-suited for lunar exploration because it is lower power, efficient, highly maneuverable, and able to traverse steep slopes and rocky terrain without human intervention. Additionally, the rover system 100 is capable of carrying a substantial science and/or engineering payload 114 and can operate reliably for several weeks to complete a mission.

The rover system 100 or mobility platform disclosed herein was devised based on the tight constraints of rover vehicles tasked with lunar PSR exploration and is expected to outperform wheeled rovers. As mentioned above, some embodiments of the rover system 100 comprise six legs 104 and are configured to walk in a way as to ensure that at least three legs 104 or feet are firmly planted on the ground at any given moment. This walking strategy improves the stability of the rover system 100, in particular during power interruptions, and reduces the overall complexity of the rover system 100 because the rover system 100 can operate with constant stability without any dynamical stabilization algorithms. Additionally, this walking strategy allows the rover system 100 to translate in any direction, rotate in place, and pose its body with six degrees of freedom while standing. While introducing the stabilizing legs 120 with one degree of freedom does introduce some limitations in leg placement when stepping onto the stabilizing legs 120, where the rover system 100 can only control the height of each stabilizing leg 120, in the context of geological exploration, this limitation does not affect the performance of the rover system 100 because it maintains a tripod stance and can select with six degrees of freedom where to place the tripod on the ground during the stabilizing step.

The rover body 102 may be a hexagonal carapace. The mobilizing legs 118 may be articulated robot arms facing outwards and towards the ground relative to the rover body 102. The mobilizing legs 118 drive all of the dexterity and stepping movements of the rover system 100. Each of the stabilizing legs 120 may be a simple four-bar mechanism which raises and lowers with respect to the rover body 102. Thus, the walking motion of the rover system 100 comprises stepping down with the mobilizing legs 118, lifting the stabilizing legs 120, moving the rover body 102 forward relative to the mobilizing legs 118, lowering the stabilizing legs 120, and repeating. This walking strategy resembles a human walking with a mobility walker where the human moves the walker forward while standing, and then steps into the walker once it is firmly planted.

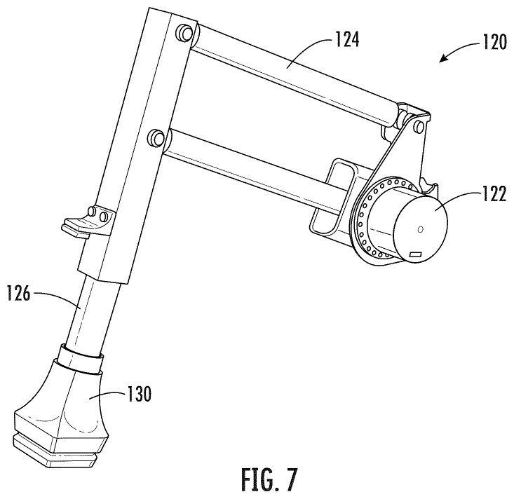

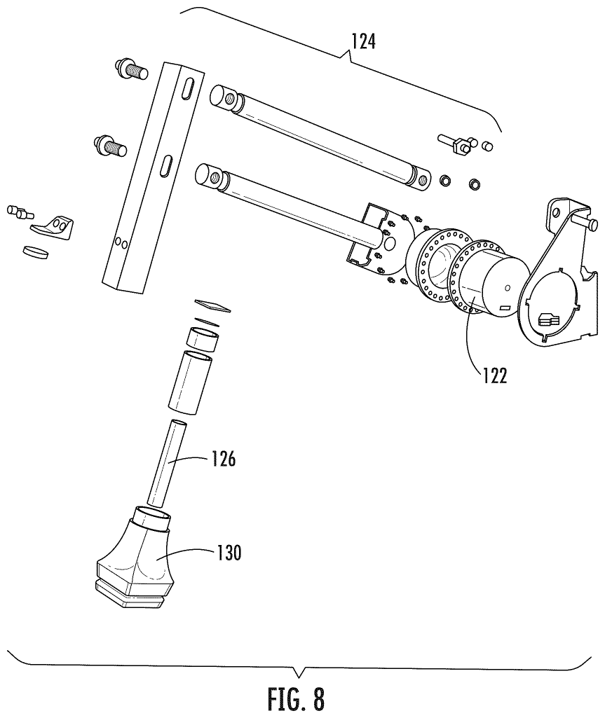

The stabilizing legs 120 allow the rover system 100 to stabilize itself during locomotion while the mobilizing legs 118 are moving into the next position. As shown in FIGS. 7 and 8, the stabilizing legs 120 are made up of a motor or actuator 122 and a four-bar mechanism 124 which allows the actuator 122 to move the leg 104 vertically during locomotion. The actuator 122 may be capable of up to 280 Nm of torque and may have an integrated 180:1 harmonic drive gearbox, an encoder, and a mechanical break. The four-bar mechanism 124 may be made with 5052 aluminum sheet metal brackets and tubing.

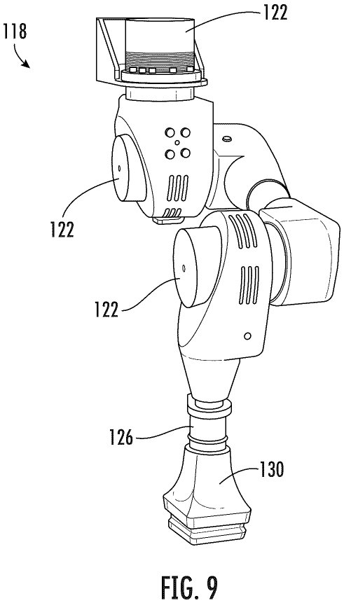

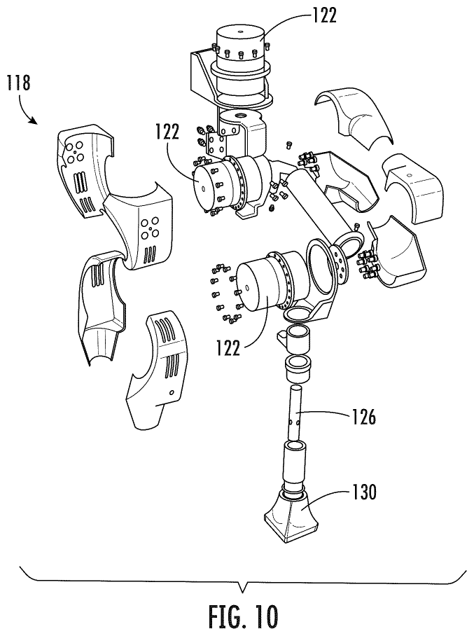

As shown in FIGS. 9 and 10, the mobilizing legs 118 may comprise a plurality of actuators 122, the number of which corresponds with the number of degrees of freedom in the mobilizing legs 118. For example, the mobilizing legs 118 may have three actuators 122 that act as a hip joint, a knee joint, and an ankle joint. The mobilizing legs 118 are the primary means of locomotion and allow the rover system 100 to move in any direction and to dynamically adjust each leg 104 for varied terrain. Each actuator 122 may be connected with 5052 aluminum sheet metal brackets and tubular leg segments. The actuator 122 may be capable of up to 280 Nm of torque and may have an integrated 180:1 harmonic drive gearbox, an encoder, and a mechanical break, similar to the stabilizing legs 120.

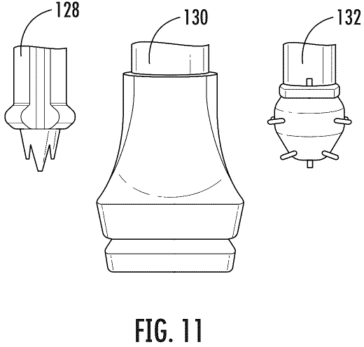

Each leg 104 may comprise a foot 126. Each foot 126 of each leg plurality of legs 104 may be configured to maximize thermal resistance while maintaining structural rigidity. Each foot 126 may be configured to maximize traction and stability. Each foot 126 may have a different variety of shoe positioned on the end of the foot 126. Examples of these varieties of shoe are shown in FIG. 11, including a talon-style shoe 128, a hoof-style shoe 130, and an Apollo-style shoe 132. Different shoes may be selected for the stabilizing legs 120 and the mobilizing legs 118. Shoe selection may be influenced by the specific terrain conditions encountered. For softer terrain, the Apollo-style shoe 132 may be used. For rocky terrain, the hoof-style shoe 130, inspired by the feet of mountain goats, may be used. For the stabilizing legs 120, the talon-style shoe 128 may provide maximum traction during locomotion.

The presently disclosed rover system 100 is advantageous over alternative hexapedal robots because it requires fewer actuators 122. Additionally, existing quadrupeds walking with at least three feet on the ground are less stable because the center of gravity can cause the robot to tip similar to a chair with a broken leg.

In some embodiments, the rover system 100 is configured to descend into steep and permanently shadowed regions (PSRs). The rover system 100 may do this in search of water-ice and other lunar volatiles. The rover system 100 may comprise the rover body 102, the base station 106, and the tether 110 joining the rover body 102 to the base station 106. The rover system 100 may also comprise a plurality of cameras 134 and other imaging instruments, such as a spectrometer and other imaging instruments configured to assist the rover in locating and mapping lunar resources. For example, the rover system 100 may comprise a Miniature Neutron Spectrometer (Mini-NS) and a Mastcam-Z. The plurality of cameras 134 and other imaging instruments may be configured to identify concentrations of water ice on the lunar surface and to image and characterize surrounding geological features such as regolith, ridges, fissures, boulders, and small craters. The plurality of cameras 134 may also comprise one or more hazard avoidance cameras and navigation cameras that are configured to gather visual data to help the rover system 100 to navigate terrain. Because the rover system 100 has 6-DOF pose control as discussed above, the rover system 100 is able to position the plurality of cameras 134, including the spectrometer and the cameras, in any position to obtain the best data. The plurality of cameras 134 may be housed inside of or mounted on the rover body 102 of the rover system 100.

The base station 106 is configured to remain stationary while the rover body 102 moves around (see FIG. 2). In some embodiments, the base station 106 comprises an electric power generator 136 and may be powered by incident sunlight. The base station may also be configured to communicatively couple with a remote device to allow data gathered by the rover system 100 to be transmitted to an interested party.

As mentioned above, the tether 110 joins the rover body 102 to the base station 106. The tether 110 may be configured to transmit electricity from the base station 106 to the rover body 102 to power the rover body 102, transmit data gathered by the rover body 102 back to the base station 106, and also support the weight of the rover body 102 and act as a mechanical rappel line between the base station 106 and the rover body 102. This tether 110 thus serves as a power source and a data link and improves the ability of the rover system 100 to explore previously inaccessible areas. For example, the rover body 102 is able to enter regions that do not receive sunlight because it has access to power through the tether 110 back to a region where the base station 106 receives sunlight and can generate more electricity as needed. Similarly, using the tether 110 as a rappel line allows the rover body 102 to descend slopes that would otherwise be too steep for the rover body 102 to maneuver down and up.

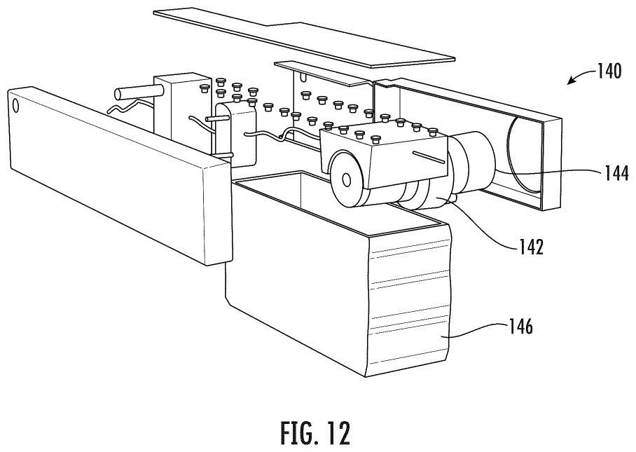

The tether 110 may be a medium voltage direct current (MVDC) cable, and may be formed such that the linear density of the tether 110 is minimized while maintaining sufficient electrical and mechanical properties. In some embodiments, the tether 110 transmits DC power. This allows all of the cross-sectional area of the electrical conductor to be used and minimizes skin-effects in power transmission. Additionally, with a DC link, power-factor correction equipment such as shunt reactors and capacitors will be minimized, and the mass and complexity of the system thereby reduced. The portions of the tether 110 not in use may be configured to wrap around a spool 138 on the rover body 102 to avoid the tether 110 from getting tangled or damaged (see FIG. 6). In some embodiments, the tether 110 may be configured to spool within the base station 106 instead of the rover body 102. FIG. 12 illustrates an exploded view of the tether boom 140 for reeling the tether 110. The tether boom 140 may comprise a capstan 142, a motor 144, and/or a slack basket 146. The capstan 142 and the motor 144 are configured to help to reel the tether 110. The slack basket 146 is configured to provide a space where slack in the tether 110 can be temporarily stored while the capstan 142 and the motor 144 operate, and is configured to help prevent the slack in the tether 110 from catching on other objects.

For communications between the base station 106 and the rover body 102, a radio frequency (RF) signal may be injected into the shared coaxial cable within the tether 110 via an RF bias tee on either end of the tether 110. Despite distortion harmonics in the MVDC power converter ripple, the injected RF signal is of a high enough frequency that it will not encounter noise from the power transmission component of the line.

One concern is that the rover body 102 will become too cold for operation. Because the presently disclosed rover body 102 is configured to explore previously unvisited areas, there are many unknowns with regard to the conditions there. For example, although good estimates exist of the surface temperatures, there is conflicting opinion and debate about the thermal conductivity of the lunar regolith in this area. While some experts believe that the regolith is so cold and sufficiently conductive that metals would freeze and fracture, other experts believe that the conductivity of the lunar soil is near zero and that little heat would be conducted away from the rover system 100, regardless of the temperature of the soil. The presently disclosed rover body 102 is therefore configured to deal with any interplanetary exploration scenarios where the planet, moon, or asteroid has little atmosphere and has extreme surface temperatures, whether hot or cold. While power is supplied to the rover system 100, such temperature control is easier because the electric heaters of the rover system 100 can be used to maintain the temperature. However, it is still likely that keeping the rover body 102 warm will be a challenge, especially within a lunar PSR due to a large temperature differential (−230° C. on the surface and 20° C. for the rover body 102) and due to regolith compaction from stepping or driving on the soil. When a relatively heavy rover presses down on the regolith, the grains may be compacted, and the vacuum thermal insulation may no longer have as strong of an effect. Additionally, if the base station 106 is no longer receiving sunlight, power may be limited to the on-board battery 108. Thus, the rover body 102 may have additional methods of temperature control, explained in more detail below.

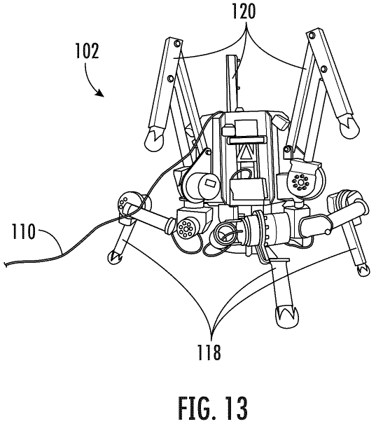

During time periods in which the base station 106 does not receive sunlight and therefore does not generate power for the rover body 102, the rover body 102 may be configured to hibernate to preserve power. During hibernation, the rover body 102 may lift all of its legs but three to reduce thermal conduction from the rover body 102 into the lunar surface, as shown in FIG. 13. Any three of the legs may be used, including legs of different types. However, it may be preferable in some situations to use legs that have lower thermal conductivity to reduce thermal conduction as much as possible. In some embodiments, each of the plurality of legs 104 is configured to minimize heat conduction from the rover body 102.

The rover body 102 may have an on-board battery 108 and a heater to maintain thermal setpoints until power is restored through the tether 110. The rover body 102 is designed to remain robust and tolerant to heat fluctuations in the environment and is configured to implement several passive thermal control mechanisms alongside active heating to accomplish thermal homeostasis within the rover. To reduce complexity, mass, and risk, the rover body 102 may have no active cooling and no coolant circulation system. All thermally sensitive components, namely electronics 112 and batteries 108, may be close to the radiator 116 to reduce the conduction path through thermal straps for heat shedding.

The rover system 100 may be configured to perform its missions either via teleoperated control and/or autonomously using onboard sensing and navigation systems. The rover system 100 may be designed to conduct a travers via a set of global waypoints from its starting location. These waypoints may be given to provide the best route for the rover body 102 based on previously known remote sensing information about the terrain. If little information is known about the terrain, and intermediate waypoints cannot be given, an end point may be supplied, and the rover body 102 may attempt to use imaging and onboard autonomous navigation to find the best route. The rover system 100 may be configured to build a digital terrain model of its surroundings using the plurality of cameras 134, including the stereoscopic navigation cameras (Navcams) in tandem with the hazard avoidance cameras (Hazcams). The plurality of cameras 134 may be configured to gather visual data to help the rover body 102 to navigate terrain. The rover body 102 may have six Hazcams, one for each side of the rover body 102, as shown in FIG. 5. The Hazcams may be mounted to each face of the rover body 102 and angled downwards to provide 360-degree visual feedback around the rover body 102 for the purpose of foot placement in extremely rocky terrain. A Navcam may be mounted in the front of the rover body 102 perpendicular to the rover body 102 for long-distance navigation planning. Although the Navcams and Hazcams primarily serve as engineering and navigation cameras, they can also be used for closely imaging the lunar surface and extracting information about rock sizes and number density. This analysis can be performed as post processing on Earth with the images captured from the engineering cameras sent to mission control. The terrain below each leg 104 can be analyzed prior to foot placement allowing the rover body 102 to choose stable footing.

The rover system 100 may implement a custom desktop application built in C++ and Python for a Linux operating system which provides a command-and-control environment for the rover system 100 using Robot Operating System (ROS). The operator may be able to monitor the health status of the rover, control the step size, step direction, and clearance height. In addition, the operator may control the rover system 100 step by step or provide a Navpath that the rover system 100 will follow. In addition, the rover system 100 may be configured to receive a set of waypoints for the rover body 102 to follow and may be configured to allow a user to monitor and control the position, velocity, and torque for each actuator 122.

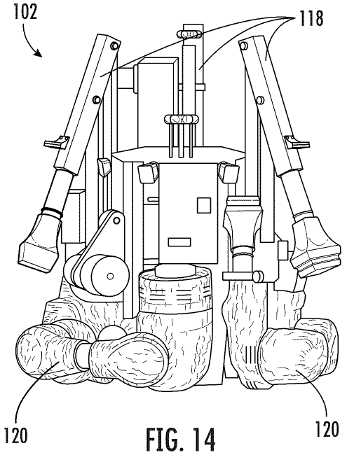

The rover system 100 disclosed herein may be configured to fold into a stowed position for flight, as shown in FIGS. 14-16. The rover is designed to operate with commercial landers, such as the Astrobotics Griffin lander, which is capable of carrying a 500 kg payload and can provide 1 W/kg of payload. Thus, the Griffin can easily carry the rover system 100 and provide the necessary power to maintain it during its mission.

As noted above, the rover body 102 is configured to move across a surface in a novel and unique process. Thus, the present disclosure is also related to a method of moving a rover system 100 across a surface. The method may comprise providing a rover system 100 with any of the features of the rover system 100 described above. The rover body 102 may be supported above the surface with the plurality of stabilizing legs 120. While continuing to support the rover body 102 above the surface with the plurality of stabilizing legs 120, the plurality of mobilizing legs 118 may be lifted off of the surface. Visual data of the surface may be gathered in a desired direction of motion, thus providing the rover system 100 with information regarding the surface where the rover body 102 desires to move. A respective contact point on the surface and a respective contact pose may be selected for each of the plurality of mobilizing legs 118. Each of the mobilizing legs 118 may then be positioned in the respective contact pose and each of the mobilizing legs 118 may be lowered to contact the surface at the respective contact point. Once the plurality of mobilizing legs 118 have contacted the surface in the desired contact pose and at the desired contact point, support of the rover body 102 may be transferred from the plurality of stabilizing legs 120 to the plurality of mobilizing legs 118. The plurality of stabilizing legs 120 may then be lifted off of the surface, the rover body 102 may be advanced in the desired direction of motion with the plurality of mobilizing legs 118, the plurality of stabilizing legs 120 may be lowered to contact the surface, and support of the rover body 102 may be transferred from the plurality of mobilizing legs 118 to the plurality of stabilizing legs 120.

The method may also comprise steps related to moving the rover body 102 into or out of the stowed position or into or out of the hibernation position discussed above. Thus, the method may comprise moving the plurality of mobilizing legs 118 and the plurality of stabilizing legs 120 out of the stowed position, in which the plurality of mobilizing legs 118 and the plurality of stabilizing legs 120 are folded up against the rover body 102, as shown in FIGS. 14-16. Similarly, the method may comprise moving the rover system 100 into the hibernation position, shown in FIG. 13, in which all of the legs 104 of the plurality of rover body 102 but three are lifted above the surface to reduce thermal conduction from the rover body 102.

Many additional implementations are possible. Further implementations are within the CLAIMS.

It will be understood that implementations of the walking rover include but are not limited to the specific components disclosed herein, as virtually any components consistent with the intended operation of various walking rovers may be utilized. Accordingly, for example, it should be understood that, while the drawings and accompanying text show and describe particular walking rover implementations, any such implementation may comprise any shape, size, style, type, model, version, class, grade, measurement, concentration, material, weight, quantity, and/or the like consistent with the intended operation of walking rovers.

The concepts disclosed herein are not limited to the specific walking rovers shown herein. For example, it is specifically contemplated that the components included in particular walking rovers may be formed of any of many different types of materials or combinations that can readily be formed into shaped objects and that are consistent with the intended operation of the walking rover. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, walking rovers may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular walking rover implementations, it should be readily apparent that a number of modifications may be made without departing from the spirit thereof and that these implementations may be applied to other implementations disclosed or undisclosed. The presently disclosed walking rovers are, therefore, to be considered in all respects as illustrative and not restrictive.

### REFERENCES CITED AND INCORPORATED BY REFERENCE

1. “Shackleton Crater's Illuminated Rim & Shadowed interior—moon: NASA science,” NASA. [Online]. Available: https://moon.nasa.gov/resources/483/shackleton-craters-illuminated-rim-shadowed-interior/. [Accessed: 23 Oct. 2022].
2. “Griffin Lander,” Astrobotic Technology, 9 Jun. 2021. [Online]. Available: https://www.astrobotic.com/lunar-delivery/landers/griffin-lander/. [Accessed: 23 Oct. 2022].
3. S. Magazine, “Five things to know about NASA's Lunar Rover ‘Viper’,” Smithsonian.com, 12 Oct. 2021. [Online]. https://www.smithsonianmag.com/science-nature/five-things-to-know-about-nasas-lunar-rover-viper-180978787/. [Accessed: 10 Jan. 2022].
4. M. A. Rosenburg, O. Aharonson, J. W. Head, M. A. Kreslavsky, E. Mazarico, G. A. Neumann, D. E. Smith, M. H. Torrence, and M. T. Zuber, “Global surface slopes and roughness of the Moon from the Lunar Orbiter Laser Altimeter,” Journal of Geophysical Research, vol. 116, no. E2, 2011.
5. V. T. Bickel and D. A. Kring, “Lunar South Pole Boulders and Boulder tracks: Implications for crew and Rover traverses,” Icarus, vol. 348, p. 113850, 2020.
6. S. May, “ADC guide and Coding Components,” NASA, 4 Aug. 2020. [Online]. Available: https://www.nasa.gov/stem/nextgenstem/moon/adc_guide_and_coding_components_fy20.html. [Accessed: 23 Oct. 2022].
7. J. E. Bares and D. S. Wettergreen, “Dante II: Technical description, results, and lessons learned,” The International Journal of Robotics Research, vol. 18, no. 7, pp. 621-649, 1999.
8. “Part number 167-2896, high voltage coaxial/shielded cable on Teledyne Reynolds Inc.,” Teledyne Reynolds Inc. [Online]. Available: http://catalog.teledynereynolds.com/item/high-voltage-wire-and-cable/high-voltage-coaxial-shielded-cable/high-voltage-coaxial-shielded-cable-2. [Accessed: 23 Oct. 2022].
9. “Lunar reconnaissance orbiter,” NASA. [Online]. Available: https://lunar.gsfc.nasa.gov/. [Accessed: 23 Oct. 2022].
10. J.-P. Williams, D. A. Paige, B. T. Greenhagen, and E. Sefton-Nash, “The global surface temperatures of the Moon as measured by the diviner lunar radiometer experiment,” Icarus, 13 Aug. 2016. [Online]. Available: https://www.sciencedirect.com/science/article/pii/S0019103516304869. [Accessed: 23 Oct. 2022]. ASU/CHARLOTTE Rover, NASA Big idea Project 30
11. “The ultimate factor of safety aircraft spacecraft its history . . . —NASA.” [Online]. Available: https://ntrs.nasa.gov/api/citations/20150003482/downloads/20150003482.pdf. [Accessed: 23 Oct. 2022].

We claim:

1. A walking rover system, comprising:
a rover having:
a rover body configured to hold a scientific payload;
a plurality of mobilizing legs mounted to the rover body, each mobilizing leg of the plurality of mobilizing legs having three actuators and three degrees of freedom;
a plurality of stabilizing legs mounted to the rover body, each stabilizing leg of the plurality of stabilizing legs having one actuator and one degree of freedom, wherein each stabilizing leg is formed as a four-bar mechanism; and
a plurality of cameras mounted to the rover body and configured to gather visual data to help the rover to navigate terrain;
wherein the plurality of mobilizing legs and the plurality of stabilizing legs alternate around the rover body such that each of the plurality of mobilizing legs is separated from adjacent mobilizing legs of the plurality of mobilizing legs by a stabilizing leg of the plurality of stabilizing legs and each of the plurality of stabilizing legs is separated from adjacent stabilizing legs of the plurality of stabilizing legs by a mobilizing leg of the plurality of mobilizing legs;
a base station having an electric power generator configured to convert incident sunlight into electric power, wherein the base station is configured to communicatively couple with a remote third party; and
a tether extending between the rover and the base station, wherein the tether is configured to transmit electricity from the base station to the rover to power the rover, transmit data gathered by the rover back to the base station, and support a weight of the rover and act as a mechanical rappel line between the base station and the rover.

2. The walking rover system of claim 1, the rover further having an imaging instrument mounted to the rover body and configured to image and characterize surrounding geological features.

3. The walking rover system of claim 1, the rover further having a spectrometer mounted to the rover body and configured to identify concentrations of water ice.

4. The walking rover system of claim 1, the rover further having a rechargeable battery mounted to the rover body and configured to power the rover when the tether is unable to transmit electricity from the base station to the rover.

5. The walking rover system of claim 1, wherein the rover body has a radiator configured to passively radiate heat from the rover body.

6. The walking rover system of claim 1, wherein each of the plurality of mobilizing legs and each of the plurality of stabilizing legs is configured to minimize heat conduction from the rover body.

7. The walking rover system of claim 1, wherein the rover is configured to move into a hibernation position in which all of the legs of the plurality of stabilizing legs and of the plurality of mobilizing legs but three are lifted above a surface beneath the rover to reduce thermal conduction from the rover body.

8. The walking rover system of claim 1, wherein the rover further comprises a tether spool mounted to the rover body configured to wind up and store an unused portion of the tether.

9. A walking rover system, comprising:
a rover having:
a rover body configured to hold a payload;
a plurality of mobilizing legs mounted to the rover body, each mobilizing leg of the plurality of mobilizing legs having three actuators and three degrees of freedom; and
a plurality of stabilizing legs mounted to the rover body, each stabilizing leg of the plurality of stabilizing legs having one actuator and one degree of freedom;
wherein the plurality of mobilizing legs and the plurality of stabilizing legs alternate around the rover body such that each of the plurality of mobilizing legs is separated from adjacent mobilizing legs of the plurality of mobilizing legs by a stabilizing leg of the plurality of stabilizing legs and each of the plurality of stabilizing legs is separated from adjacent stabilizing legs of the plurality of stabilizing legs by a mobilizing leg of the plurality of mobilizing legs.

10. The walking rover system of claim 9, the rover further having an imaging instrument mounted to the rover body and configured to image and characterize surrounding geological features.

11. The walking rover system of claim 9, the rover further having a spectrometer mounted to the rover body and configured to identify concentrations of water ice.

12. The walking rover system of claim 9, the rover further having a rechargeable battery mounted to the rover body and configured to power the rover.

13. The walking rover system of claim 9, wherein the rover body has a radiator configured to passively radiate heat from the rover body.

14. The walking rover system of claim 9, wherein each of the plurality of mobilizing legs and each of the plurality of stabilizing legs is configured to minimize heat conduction from the rover body.

15. The walking rover system of claim 9, wherein the rover is configured to move into a hibernation position in which all of the legs of the plurality of stabilizing legs and of the plurality of mobilizing legs but three are lifted above a surface beneath the rover to reduce thermal conduction from the rover body.

16. A method of moving a walking rover system across a surface, the method comprising:
providing the walking rover system, the walking rover system comprising a rover body, a plurality of mobilizing legs mounted to the rover body, and a plurality of stabilizing legs mounted to the rover body, wherein each of the plurality of mobilizing legs has three degrees of freedom and each of the plurality of stabilizing legs has one degree of freedom;
supporting the rover body above the surface with the plurality of stabilizing legs;
while supporting the rover body above the surface with the plurality of stabilizing legs:
lifting the plurality of mobilizing legs off of the surface;
gathering visual data of the surface in a desired direction of motion;
selecting a respective contact point on the surface and a respective contact pose for each of the plurality of mobilizing legs;
positioning each of the plurality of mobilizing legs in the respective contact pose; and
lowering each of the plurality of mobilizing legs to contact the surface at the respective contact point;
transferring support of the rover body from the plurality of stabilizing legs to the plurality of mobilizing legs;
lifting the plurality of stabilizing legs off of the surface;
advancing the rover body with the plurality of mobilizing legs in the desired direction of motion;
lowering the plurality of stabilizing legs to contact the surface; and
transferring support of the rover body from the plurality of mobilizing legs to the plurality of stabilizing legs.

17. The method of claim 16, further comprising moving the plurality of mobilizing legs and the plurality of stabilizing legs out of a stowed position in which the plurality of mobilizing legs and the plurality of stabilizing legs are folded up against the rover body.

18. The method of claim 16, further comprising moving the walking rover system into a hibernation position in which all of the legs of the plurality of stabilizing legs and of the plurality of mobilizing legs but three are lifted above the surface to reduce thermal conduction from the rover body.

19. The method of claim 16, wherein each of the plurality of mobilizing legs and each of the plurality of stabilizing legs is configured to minimize heat conduction from the rover body.

20. The method of claim 16, wherein the plurality of mobilizing legs and the plurality of stabilizing legs alternate around the rover body such that each of the plurality of mobilizing legs is separated from adjacent mobilizing legs of the plurality of mobilizing legs by a stabilizing leg of the plurality of stabilizing legs and each of the plurality of stabilizing legs is separated from adjacent stabilizing legs of the plurality of stabilizing legs by a mobilizing leg of the plurality of mobilizing legs.
